(19) United States
(12) Patent Application Publication
(10) Pub. No.: US 2018/0003291 A1
(43) Pub. Date: Jan. 4, 2018

(54) GEAR UNIT FOR MOTOR VEHICLE

(71) Applicant: Ford Global Technologies, LLC, Dearborn, MI (US)

(72) Inventor: Michael Georg Figura, Dormagen (DE)

(73) Assignee: Ford Global Technologies, LLC, Dearborn, MI (US)

(21) Appl. No.: 15/634,822

(22) Filed: Jun. 27, 2017

(30) Foreign Application Priority Data
Jun. 29, 2016 (DE) DE102016211681.9

(51) Int. Cl. F16H 57/12; F16H 1/16; F16H 57/021; B62D 5/04

(52) U.S. Cl. CPC F16H 57/12; F16H 57/021; F16H 1/16; B62D 5/04; F16H 2057/0213; F16H 2057/127

(57) ABSTRACT

A gear unit for a motor vehicle having a drive shaft extending axially and mounted rotatably, and a worm gear shaft which cooperates with a worm gear wheel. A torque-transmitting coupling connects the drive shaft to one end of the worm gear shaft with the other end supported by a bearing. A pretension element loads the bearing and correspondingly the worm gear shaft so the worm gear shaft is biased or pressed against the worm gear wheel. The torque-transmitting coupling provides a suitable connection between the drive shaft and worm gear shaft.

### CROSS-REFERENCE TO RELATED APPLICATIONS

Not Applicable.

### BACKGROUND OF THE INVENTION

### 1. Field of the Invention

The present invention relates generally to a gear unit for a motor vehicle; and more particularly, to a gear unit having a worm gear shaft coupled at one end to a drive shaft via a torque-transmitting clutch arrangement.

### 2. Description of Related Art

Modern motor vehicles are usually equipped with power-assisted steering to considerably reduce the effort to turn the steered wheels during driving and, when stopped or moving slowly. Power steering may also provide feedback of forces acting on the steered wheels and may generate a particular steering moment to point the driver to a recommended steering movement. Both hydraulic and motorized power steering systems are used. With a motorized power steering system, an electric servo motor with a drive shaft acts on a worm gear shaft, which acts on a worm gear wheel. The worm gear wheel sits on the actual steering shaft, which acts through a pinion on a steering rack. Similar systems having a servo motor, worm gear shaft, and worm gear wheel are also used in other areas of motor vehicles, for example, window lifters.

Although theoretically, under ideal conditions, an optimum engagement with the worm gear wheel it is possible with a worm gear shaft rotating around a fixed axis, in practice engagement may deteriorate due to production-induced or installation-induced inaccuracies, wear effects, soiling, and environmental influences such as moisture and temperature. The above influences, alone or in combination, may lead to the engagement between the worm gear shaft and worm gear wheel being too loose and/or too tight. Too tight an engagement is also a problem since it leads to increased friction, makes the gears difficult to move, and increases wear.

One method known in the prior art for alleviating such problems is to mount the worm gear shaft, on a side facing the drive shaft, with a first roller bearing, normally a ball bearing, that allows a degree of tilt or pivot movement transversely to the axial direction of the worm gear shaft. A second roller bearing, normally a ball bearing, mounts the opposite side of the worm gear shaft to a gear housing or structure through a spring. The spring exerts a bias, applies a load, on the worm gear shaft, in the direction of the worm gear wheel. The worm gear shaft pivots about the first roller bearing to remain in approximately constant engagement with the worm gear wheel.

One disadvantage is that the pivotability is usually only possible through a greater play in the region of the first roller bearing, leading to the possibility of vibrations and associated rattling noises, which are undesirable NVH aspects. The precision of the gear mechanism is also adversely affected because the axial and radio position of the worm gear shaft cannot be set precisely in the region of the first roller bearing. If bearing play is reduced in the region of the roller bearing, it usually leads to increased friction detracting from precision of control and leading to increased wear. Offsetting the action line of the force resulting from the engagement with the worm gear wheel on the worm gear shaft, towards the center axis of the latter, leads to a different level of friction and gear efficiency depending on the rotation direction of the worm gear shaft. This allows a degree of pivotability without the actual roller bearing needing unnecessary play, but the pivot axis is not defined precisely because of the structure of the pivot bearing. Also, the stiffness of the system against axial displacements is, in general, low and cannot be set in a targeted fashion. This in turn adversely affects the precision of the gear mechanism, and the engagement of the worm gear shaft with the worm gear wheel is not optimal. The engagement of the toothing under load is usually not optimal, and the corresponding gear play leads to audible and undesirable clattering noise.

### SUMMARY OF THE INVENTION

A gear unit for a motor vehicle including a drive shaft extending axially and mounted rotatably in a housing. A worm gear wheel and a worm gear shaft cooperating with the worm gear wheel. A torque-transmitting coupling connects the worm gear shaft and the drive shaft to transfer rotational movement or motion of the drive shaft to the worm gear shaft and correspondingly to the worm wheel. One end of the worm gear shaft supported by a bearing and the opposite end supported by the torque-transmitting coupling wherein the worm gear shaft is supported only by the torque-transmitting coupling and the bearing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic cross-sectional view depicting an exemplary embodiment of a gear unit according to the invention.

### DETAILED DESCRIPTION OF THE PREFERRED EMBODIMENTS

The following description of the preferred embodiment(s) is merely exemplary in nature and is in no way intended to limit the invention, its application, or uses.

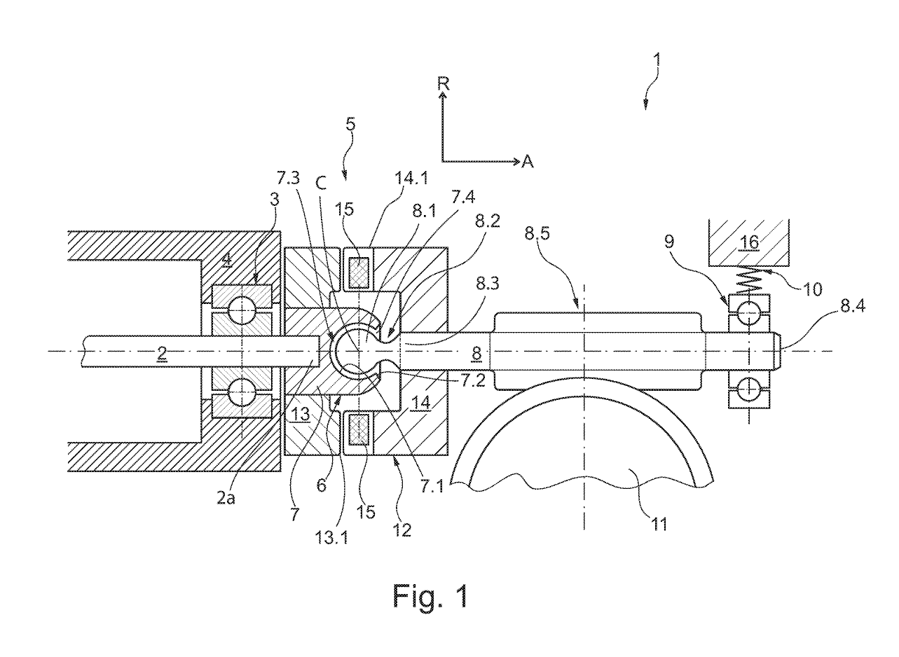

FIG. 1 shows a gear unit 1 according to the invention, used for example in a power steering system of a car. The diagrammatic depiction is partially simplified. A metallic drive shaft 2 extends in an axial direction A and is mounted rotatably on a motor housing 4 via two ball bearings 3, only one of which is visible in FIG. 1. The motor housing containing a servo motor (not shown), a rotor of which is connected to and rotationally fixedly to the drive shaft 2. A ball head receiver 7 of a ball head coupling 6 attached or fixed on an end 2a of the drive shaft 2 outside the motor housing 4 rotates with the drive shaft 2.

The ball head receiver 7 may be made of metal. As shown, the ball head receiver 7 surrounds a ball head 8.1 formed integrally with a worm gear shaft 8. The worm gear shaft 8 runs approximately coaxially to the drive shaft 2 and is also made of metal, for example steel. A tapered portion 8.2 adjoins the ball head 8.1 in the direction towards the worm gear shaft 8. An inside surface 7.1 of the ball head receiver 7 forms a socket 7.3 corresponding in shape to the outer form or configuration of the ball head 8.1, whereby the ball head receiver 8.1 rotates, to a certain extent, in the ball head receiver; as a result, the worm gear shaft 8 pivots approximately around the center point C of the ball head 8.1. The pivot movement in a radial direction. A constricted region 7.2 on the open side of the socket 7.3 secures the ball head 8.1 against extraction from the ball head receiver 7 since the opening 7.4 is smaller than the radius of the ball head 8.1. To avoid an undesirable play between the ball head receiver 7 and the ball head 8.1, the inside surface 7.1 socket 7.3 may have a plastic or similar material coating (not shown) that largely fills any gap between the ball head receiver 7 and the ball head 8.1. The coating may in some cases reduce the friction between the two elements.

The ball head 8.1 is formed at a first end 8.3 of the worm gear shaft 8. At a second, opposite end 8.4, the worm gear shaft is mounted in a loose ball bearing 9 connected via a spring 10, shown diagrammatically, to a gear housing 16 that may be fixedly connected to or part of the motor housing 4. The spring 10 pretensions the worm gear shaft 8 against a worm gear wheel 11, which cooperates with a worm screw 8.5 of the worm gear shaft 8. This, in connection with the pivotable mounting of the worm gear shaft 8 in the ball head coupling 6, ensures optimal engagement between the worm gear shaft 8 and the worm gear wheel 11.

The ball head coupling 6 is part of a mounting assembly or connection, seen generally at 5, between the drive shaft 2 and worm gear shaft 8. The mounting assembly or coupling 5 includes a claw clutch 12. The claw clutch 12 includes a first clutch part 13 rotationally and fixedly connected to the ball head receiver 7, and correspondingly, to the drive shaft 2. The claw clutch 12 includes a second clutch part 14 rotationally and fixedly connected to the worm gear shaft 8. As shown, the first clutch part 13 and second clutch part 14 each include respective axially extending, in the axial direction A, claws or dogs 13.1, 14.1. The clutch parts 13, 14 cooperating to transmit a torque from the drive shaft 2 to the worm gear shaft 8. To prevent noise development resulting from engagement between the two clutch parts 13, 14, elastic elements 15 are arranged in the tangential direction between the claws 13.1, 14.1.

Because the claw clutch 12 is configured to transmit a torque which depends on tangential forces, it transmits no substantial axial or radial forces between the drive shaft 2 and the worm gear shaft 8. The position of the ball head 8.1 is established by the cooperation with the ball head receiver 7 in both the axial direction A and in the radial direction R, besides slight, negligible deviations, the ball head coupling 6 absorbs forces in both the axial direction A and the radial direction R. Tangential forces play only a secondary role in the region of the ball head coupling 6; specifically, the ball head coupling 6 does not transmit torque from the drive shaft 2 to the worm gear shaft 8 whereby seizing or sticking of the ball head coupling 6 is unlikely.

Because the worm gear shaft 8 is mounted pivotably on the drive shaft 2 via the mounting assembly or coupling 5, and in particular the ball head coupling 6, no additional bearings, e.g. ball bearings, are required in the region of the first end 8.3. If used, such ball bearings must have considerable play to allow pivotability of the worm gear shaft 8, in contrast, the ball head coupling 6 produces an almost play-free pivotable mounting assembly or coupling 5 between the drive shaft 2 and worm gear shaft 8 enabling the axial and radial position in the region of the ball head 8.1 to be defined with precision. Also, audible clattering noise associated with knocking of the ball head 8.1 and ball head receiver 7 on each other, is suppressed.

The gear unit 1 may be used in a motor vehicle, in particular private cars and commercial vehicles. In one example, the gear unit 1 may, in particular, be a gear unit for a power steering system, although other applications are possible, for example, window lifters, electric seat adjustment mechanisms, sliding roofs, movable panoramic sunroofs or other moving or movable mechanisms.

The gear unit 1 has an axially running, rotatably mounted drive shaft 2. The drive shaft 2 normally connected directly to the rotor of a servo motor, or may form part of the rotor. The rotatable mounting normally takes place relative to a stationary base part, for example, a motor housing 4. The rotatably mounted drive shaft 2 is typically supported by two spaced bearings spaced apart from each other, in particular ball bearings or other roller bearings. The drive shaft 2 extends axially, meaning the drive shaft defines an axial direction, simultaneously defining a radial and a tangential direction.

The gear unit 1 also includes worm gear shaft cooperating with a worm gear wheel 11. A mounting assembly or coupling 5 couples one end 8.3 of the worm gear shaft 8 to the drive shaft 2. The other end 8.4 of the worm gear shaft 8 is mounted by a roller bearing 9 loaded via a pretension element, for example a spring 10, so the worm gear shaft 8 is pretensioned against the worm gear wheel 11. The worm gear shaft 8 generally extends coaxially to the drive shaft 2, wherein the mounting assembly or coupling 5 transmits torque from the drive shaft 2 to the worm gear shaft 8. The worm gear shaft 8 engages with the worm gear wheel 11, whereby the rotary motion of the drive shaft 2 is stepped down. As illustrated, in the region of the first end 8.3, the worm gear shaft eight is coupled to the drive shaft 2 via the mounting assembly or coupling 5, and in the region of the second end 8.4 is mounted by a roller bearing 9. This roller bearing 9 may be a ball bearing. The roller bearing 9 preferably having as little play as possible, and connected to a stationary base part (housing or similar) not rigidly but via the pretension element 10. The pretension element 10 elastically configured to a certain extent, for example the pretension element 10 may be a spring made of metal or fiber-reinforced plastic, an elastomer, or elastomeric element. The pretension element 10 ensures a pretension of the worm gear shaft 8 in the direction towards the worm gear wheel 11 via force-loading of the roller bearing 9. The corresponding pretension acts to ensure that the worm gear shaft 8 remains in engagement with the worm gear wheel 11, wherein the pretension element 10, because of its elastic property, simultaneously allows deflection of the worm gear shaft 8, whereby the friction forces between the worm gear shaft 8 and the worm gear wheel 11 may be limited.

As illustrated, the mounting assembly or coupling 5, in one example the claw clutch 12, pivotably mounts or connects the worm gear shaft 8 to the drive shaft 2 enabling the worm gear shaft 8 to pivot transversely to the axial direction. The mounting assembly or coupling 5 serves not only to transmit torques associated with tangential forces, but forms a bearing for the worm gear shaft 8 on the drive shaft 2 allowing a pivot movement transversely to the axial direction A, i.e. in particular movement of the worm gear shaft 8 in the radial direction. Such pivotable movement by the worm gear shaft 8 is needed when it, for example, follows a temporally and/or spatially uneven outer radius of the worm gear wheel 11 or movement of the worm gear shaft by the pretension element 10. Using the mounting assembly or coupling 5, including for example the claw clutch 12, avoids the necessity for providing a ball bearing adjacent one end 8.3 of the worm gear shaft 8 with the ball bearing having a suitable amount of play to achieve the pivotability.

As illustrated, the pivotable coupling between the drive shaft 2 and worm gear shaft 8, is to a certain extent created via the drive shaft 2. This is advantageous where the mounting assembly or coupling 5 may be located relatively close to the rotary point of the pivot movement, whereby the absolute movements or pivot angle are relatively small. In contrast, ball bearings are often located relatively far from the rotary point of the pivot movement, so greater movements must take place, in turn requiring correspondingly large play in the region of the bearing.

The worm gear shaft 8 at one end 8.3 is mounted only indirectly via the drive shaft 2. At the end 8.3 facing the drive shaft 2 there is no mounting via a ball bearing or similar mechanism fixed to a housing or similar support structure, instead the mounting assembly or coupling 5 forms the only mounting for one side or end of the worm gear shaft 8, whereby the rotational support for one end 8.3 or sided of the worm gear shaft 8 is provided indirectly via the drive shaft 2 rotatably supported in the stationary base part or motor housing 4 by the bearing 3. Normally two bearings are required for the drive shaft, one on each end and two additional bearings for the worm gear shaft, again one on each end, in total four bearings are required. In the exemplary embodiment only three bearings are necessary, two for the drive shaft and one, the roller bearing 9 associated with the end 8.4 of the worm gear shaft 8. As shown the mounting assembly or coupling 5, and correspondingly the end 8.3 of the worm gear by the bearing 3 supporting the drive shaft 2.

In the exemplary embodiment, the mounting assembly or coupling 5 includes a claw clutch 12 including second clutch 14 establishing an axial and a radial position of the worm gear shaft 8, and a first clutch 13 via which torque can be transmitted from the drive shaft 2 to the worm gear shaft 8. As shown, the claw clutch 12 is divided functionally and physically into two parts, a first clutch 13 and a second clutch 14. The second clutch 14 establishes a position of the worm gear shaft 8 relative to the drive shaft 2 both axially and radially. This may be the position of the rotary point of the above-mentioned pivot movement. The position of other parts of the worm gear shaft 8, in particular in the region of the roller bearing 9, is evidently not established. The term “establishing” the position here always means that a degree of play may still exist; the term “restriction” or “limitation” of the position it could therefore also be used. The first clutch 13 and second clutch 14 both configured to allow the above-mentioned pivot movement relative the axial direction. The first clutch may be configured so it does not transmit torque, or only to a negligible extent (directly to the worm gear shaft). This function is performed by the second clutch, which need not itself be able to transmit radial and/or axial forces. The two clutches may have different functions, and hence may also be configured, optimized, or adjusted in this respect. The first clutch, including the ball head coupling 6, is preferably at least partially radially inside the second clutch. This may be advantageous where the first clutch, may define the rotary point of the pivot movement. A particular advantage here is that the first clutch normally need not transmit large forces, whereby the wear thereof is reduced and the risk of seizing of this clutch is low.

Preferably, the first clutch part 13 includes the ball head coupling 6. The ball head coupling 6, receives a spherical ball head 8.1, or at least a ball-shaped portion, in a corresponding ball head receiver 7, defining an axial and radial position. The ball head receiver 7 normally has a constricted portion 7.2 preventing extraction of the ball head 8.1 from the ball head receiver 7. As illustrated, the ball head 8.1 pivots relative to the ball head receiver 7. In particular, the worm gear shaft 8 pivots about the center point C of the ball head 8.1. Put another way, the ball head coupling forms a ball joint.

As illustrated in FIG. 1, the ball head 8.1 is on an end 8.3 of the worm gear shaft 8 and the ball head receiver 7 receiving the ball head 8.1 of the worm gear shaft eight is connected to the drive shaft 2. The ball head receiver 7 at least partially surrounds the ball head 8.1. In particular, the ball head receiver 7 tapers radially inward in a portion facing the worm gear shaft 8 forming a constricted region 7.2 adjacent an opening 7.4 preventing axial extraction of the ball head 8.1. A tapered portion 8.2 of the worm gear shaft 8 extends between the ball head 8.1 and the worm gear shaft eight. Both the ball head receiver 7 and the ball head 8.1 may be made of metal, for example, steel. However other materials such as plastic, in particular fiber-reinforced plastic, or ceramic are conceivable. In principle, neither the ball head 8.1 nor the ball head receiver 7 need be rotationally fixed to the shaft 2; normally however, a rigid connection is preferred. Alternatively, the reverse arrangement of ball head 8.1 and ball head receiver 7 is contemplated, wherein a ball head is connected to the drive shaft 2, and a ball head receiver receiving the ball head is connected to the worm gear shaft 8.

In one embodiment, the ball head 8.1 is produced separately and then connected to the worm gear shaft 8 or drive shaft 2, for example, by bolting, welding, bonding or similar. Preferably, the ball head 8.1 is formed integrally with the worm gear shaft 8 or the drive shaft 2. As a production process, the ball head 8.1 may be produced by casting, cold or warm forming, or also by material-removal machining. In particular but not exclusively, when formed integrally, an outer diameter of the ball head 8.1 may correspond at most to an outer diameter of other parts of the worm gear shaft 8 or drive shaft 2.

To establish the axial and/or radial position in the region of the ball head coupling 6, the ball head 8.1 or the ball head receiver 7 may have a coating that partially fills a gap between the ball head 8.1 and ball head receiver 7. For example, the ball head 8.1 and the ball head receiver 7 may be made of metal, making it difficult to ensure that the ball head 8.1 is always received play-free in the ball head receiver 7, in particular under different environmental conditions. An additional embodiment may include, for example, fully or partially coating the ball head 8.1 or inside of the ball head receiver 7 with a plastic, wherein the plastic ideally has a degree of elasticity that compensates for dimensional deviations between the internal dimension of the ball head receiver 7 and the external dimension of the ball head 8.1. Also, the coating may reduce the friction between the ball head 8.1 and ball head receiver 7.

Preferably, the first clutch part 13 of the mounting assembly or coupling 5 connects to and is rotationally fixed to the drive shaft 2. The second clutch part 14, which cooperates with the first clutch part 13, connects to and is rotationally fixed to the worm gear shaft 8. The respective connections may also include indirect connections using an interposed further component. In addition, the respective clutch parts 13, 14 may be formed at least partially integrally with the respective shafts 2, 8. The two clutch parts 13, 14 may cooperate together directly or through at least one interposed component. To achieve a torque transfer, an interference fit exists in the tangential direction. This may be supplemented if required by a force fit.

In one exemplary embodiment, the mounting assembly or connection is formed or configured as a claw clutch 12, wherein at least one of the clutch parts 13, 14 includes one or more claws 13.1, 14.1 extending axially in the direction of the other clutch part. As illustrated, both the first and the second clutch parts 13, 14 have several claws 13.1, 14.1. These intermesh directly or cooperate through at least one interposed element. The claws 13.1, 14.1 may be in a region radially on the outside relative to the ball head receiver 7, or the ball head coupling 6.

In an additional embodiment, at least one elastic element 15 is arranged between the first clutch part 13 and the second clutch part 14, in particular when the mounting assembly or coupling 5 is configured as a claw clutch 12. The elastic element 15 helps prevent noise caused by a possible knocking of the two clutch parts 13, 14 against each other. The elastic element 15 may be interposed in the axial direction and/or the tangential direction. When interposed in the tangential direction, the coupling between the drive shaft 2 and the worm gear shaft 8 becomes “softer”, that may have a negligible effect, depending on the elasticity and thickness of the elastic element 15. Since the elastic element 15 prevents direct contact between the clutch parts 13, 14, under certain circumstances it may also reduce wear on the two clutch parts 13, 14. The elastic element 13, 14 may be made of an elastomer such as rubber. It is also conceivable that parts of the elastic element 15 are formed comparatively non-elastically.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gear unit for a motor vehicle comprising:
a drive shaft extending axially and mounted rotatably;
a worm gear wheel;
a worm gear shaft cooperating with said worm gear wheel;
a torque-transmitting coupling connecting a first end of said worm gear shaft to said drive shaft;
a bearing supporting a second end of said worm gear shaft;
a pretension element acting on said bearing and correspondingly biasing said worm gear shaft against said worm gear wheel; and
said worm gear shaft supported only by said torque-transmitting coupling and said bearing.

2. The gear unit of claim 1 wherein the torque-transmitting coupling establishes an axial and a radial position of said first end of said worm gear shaft and pivotally supports said first end of said worm gear shaft whereby said worm gear shaft pivots transversely to a longitudinal axis of said drive shaft.

3. The gear unit of claim 1 wherein said torque-transmitting coupling includes a ball head coupling connected to said drive shaft, said ball head coupling including a ball head receiver sized to receive a ball head of said worm gear shaft.

4. The gear unit of claim 3 wherein said ball head is formed integrally with said worm gear shaft.

5. The gear unit of claim 4 wherein one of said the ball head and said ball head receiver includes a coating that at least partially fills a gap between them.

6. The gear unit of claim 1 wherein said torque-transmitting coupling includes a first clutch part rotationally fixed to said drive shaft and a second clutch part, cooperating with said first clutch part, rotationally fixed to said worm gear shaft.

7. The gear unit of claim 1 wherein said torque-transmitting coupling includes a claw clutch.

8. The gear unit of claim 6 including at least one elastic element arranged between said first clutch part and said second clutch part.

9. The gear unit of claim 3 wherein said worm gear shaft pivots about said ball head.

10. A gear unit for a motor vehicle comprising:
a drive shaft extending axially and mounted rotatably;
a worm gear wheel;
a worm gear shaft cooperating with said worm gear wheel;
a torque-transmitting coupling connecting said worm gear shaft and said drive shaft;
a bearing supporting said worm gear shaft; and
said worm gear shaft supported only by said torque-transmitting coupling and said bearing.

11. The gear unit of claim 10 including said bearing supporting said worm gear shaft on one end, said torque-transmitting coupling supporting said worm gear shaft on an opposite end, and said worm gear engaging said worm gear shaft between said bearing and said torque-transmitting coupling.

12. The gear unit of claim 10 including a pretension element biasing said worm gear shaft towards said worm gear.

13. The gear unit of claim 10 wherein said torque transmitting coupling forms a pivot connection between said drive shaft and said worm gear such that said worm gear shaft pivots transversely to said axial direction of said drive shaft.

14. The gear unit of claim 13 wherein said torque-transmitting coupling includes a first clutch part rotationally fixed to said drive shaft and a second clutch part, cooperating with said first clutch part, rotationally fixed to said worm gear shaft.

15. The gear unit of claim 14 wherein said torque-transmitting coupling includes a ball head coupling connected to said drive shaft, said ball head coupling including a ball head receiver sized to receive a ball head of said worm gear shaft.
